(19) United States
(12) Patent Application Publication
(10) Pub. No.: US 2017/0235785 A1
(43) Pub. Date: Aug. 17, 2017

(54) Systems and Methods for Robust, Incremental Data Ingest of Communications Networks Topology

(71) Applicant: CENX, Inc., Ottawa (CA)

(72) Inventors: Paul Feltham, Ottawa (CA); Marc-Antoine Boutin, Ottawa (CA); Eamonn Garry, Ottawa (CA); Edward Beingessner, Ottawa (CA); Joel Thomson, Ottawa (CA)

(21) Appl. No.: 15/436,253

(22) Filed: Feb. 17, 2017

Related U.S. Application Data
(60) Provisional application No. 62/296,438, filed on Feb. 17, 2016.

(51) Int. Cl. G06F 17/30; H04L 12/24; H04W 16/18

(52) U.S. Cl. CPC G06F 17/30371; H04W 16/18; H04L 41/12; H04L 41/14; G06F 17/30312; G06F 17/30451; G06F 17/30483; G06F 17/30569; G06F 17/30516; G06F 17/3053; G06F 17/30554

(57) ABSTRACT

Systems and methods are disclosed for managing network elements in a telecommunications network. In an embodiment, a real-time processing module processes stream data representing one or more network elements in the telecommunications network to build a real-time view. The real-time processing module stores the real-time view in a view database. A batch processing module processes snapshot data representing all the network elements in the telecommunications network to build a batch view. The batch processing module processes the snapshot data slower than the real-time processing module processes the stream data. The batch processing module saves the batch view in the view database. A presentation module presents a selected view from the view database for display.

### BACKGROUND

Field

This field is generally related to managing network elements in a telecommunications network.

Background

Network data usage has increased rapidly in recent years. Network service users demand higher bandwidth with better quality and secure connectivity. Modern network service providers operate local, regional, and nationwide networks to provide connectivity to users. These networks are built with a variety of equipment to perform various tasks, and such equipment may be manufactured by multiple vendors. Each piece of equipment may be complex enough to handle hundreds to thousands of simultaneous connections, and different pieces of equipment may be widely dispersed across a region. Wireless base stations, for example, may be geographically distributed across a city to optimize coverage and efficiency.

To meet user demand, network operators are investing heavily in network infrastructure and new applications to increase network capacity and maintain consistent performance. Today's network infrastructure is evolving faster than ever due to significant innovations in high-speed mobile broadband, cloud-based applications, network functions virtualization (NFV), software-defined networking (SDN), carrier Ethernet, and IP virtual private networks (VPNs). These advances in network technologies are impacting the underlying networks upon all network service providers. Service providers introduce 4G technology, cloud-based infrastructure, NFV, and SDN to better scale and manage their services and infrastructure assets. These dynamics have been fueling a transformation from TDM-based bandwidth services to carrier Ethernet and layer 3 IP services such as IP-VPN and Multiprotocol Label Switching (MPLS) connectivity.

For example, NFV and SDN are two emerging technologies that are expanding the transformation of service provider network services. NFV uses virtualization technologies to design, deploy, and manage network services. NFV decouples the network functions, such as firewall, network address translation (NAT), domain name service (DNS), load balancing, WAN optimization, and intrusion detection, from dedicated hardware appliances so that these network functions can execute in software and processes running within virtual machines. SDN separates control and forwarding functions, centralizes management, and programs network behavior using well-defined interfaces. SDN enables network control to become directly programmable, and the underlying infrastructure can be abstracted from applications and network services. With SDN and NFV, service providers can provide differentiated, revenue-generating service offerings to their end customers while reducing operational costs and simplifying network management.

Another extension is Voice over Long Term Evolution (VoLTE), which allows service providers to offer voice communication services over their high speed 4G LTE infrastructures that was traditionally used for data only, maximizing the value of service providers' investment. VoLTE is moving into mainstream production globally. As service providers are deploying VoLTE, service providers are also leveraging NFV technology to build out their VoLTE infrastructure more efficiently and cost effectively.

These disruptive technologies lead to significant challenges for network service providers because network transformation is complex and labor-intensive. Service providers need to build out network infrastructure leveraging emerging technologies while also operating within their existing infrastructure and maintaining the high quality of service end users expect.

Accommodating new technologies can increase the complexity of network operations. The increased operational complexity may include, for example, lengthy circuit turn-up time, inventory inaccuracy, challenges in accurately resolving faults, or unreliable performance for high value applications such as video and VoLTE. To handle this complexity, today's mobile, wire line, and cloud data center service providers are looking for new ways to design, implement, and manage their network infrastructures.

Conventional operations support systems (OSSs) can no longer simply be tweaked to support end-to-end management of increasingly complex network infrastructures. Conventional OSSs are systems used by service providers to manage their networks (e.g., telephone networks or data networks). Conventional OSSs provide functionality including network inventory, fault management, service provisioning, and network configuration. Conventional OSSs often utilize well-known, existing network management models to manage their network elements in service providers' network infrastructures. Well-known examples of network management models include FCAPS and OAMPT.

FCAPS stands for fault, configuration, accounting, performance, and security, which are categories that define network management tasks. FCAPS is the International Organization for Standardization (ISO) Telecommunications Management Network model and framework for network management. Fault management is related to identifying, correcting, and logging network problems (i.e., faults) to minimize network downtime. Configuration management is related to gathering configurations from network devices and applying configurations to network devices. Configurations may be hardware and programming changes, including the addition, deletion, or modification of network equipment and programs in the communications network. Accounting management focuses on gathering network usage statistics so that individual users, departments, or business units can be properly billed for accounting purposes. Performance management is concerned with managing the overall performance of the network and ensuring that network performance remains at acceptable levels. Security management is related to protecting the network against unauthorized access.

Another well-known network management model is OAMPT. OAMPT stands for operations, administration, maintenance, provisioning, and trouble shooting. OAMPT describes five types of network management tasks: operational management, administration, maintenance, provisioning, and troubleshooting. Operational management is concerned with day-to-day normal network operations. Administration includes support procedures for day-to-day operations. The support procedures can include, for example but not limited to, common passwords, equipment and tools access, and customer service report. Maintenance focuses on configuration and hardware changes in response to system deterioration. These changes include, for example but not limited to, scheduling service provider maintenance, standard network equipment configuration changes, routine equipment checks, hardware changes, and software/firmware upgrades. Provisioning is related to configurations that add, update, and remove network hardware equipment and network services. Troubleshooting involves diagnosis of network failures.

To more effectively manage today's complex networks, better modeling and accommodation of changes in network configuration data is needed.

### BRIEF SUMMARY

Systems and methods are disclosed for managing network elements in a telecommunications network. In an embodiment, a server implemented on one or more processors includes a real-time processing module, a batch processing module, and a presentation module. The real-time processing module processes stream data representing changes to one or more network elements in a telecommunications network to build a real-time view of the telecommunications network. The real-time processing module may build the real-time view based on the stream data and a most recent view in the view database. The real-time processing module then saves the real-time view in a view database. The real-time processing module may save the real-time view as the most recent view. The batch processing module processes snapshot data representing complete information of all the network elements in the telecommunications network to build a batch view of the telecommunications network. The batch processing module processes the snapshot data slower than the real-time processing module processes the stream data. The batch processing module stores the batch view in the view database. The batch processing module may override the most recent view stored by the real-time processing module and store the batch view as the most recent view in the view database. The presentation module presents a selected view from the view database for display.

Method and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and foiiu part of the specification, illustrate the present disclosure and, together with the description, further serve to explain the principles of the disclosure and to enable a person skilled in the relevant art to make and use the disclosure.

FIG. 1 is a diagram illustrating a network model that includes a plurality of entities, each entity representing a type of network element in a telecommunications network, according to an embodiment.

FIG. 2 is a diagram illustrating an example system for managing data related to network elements in a telecommunications network from one or more source providers, according to an embodiment.

FIG. 3 is a flowchart illustrating an example method for processing data related to network elements in a telecommunications network, according to one embodiment.

FIG. 4 is a flowchart illustrating an example method for the real-time processing module to process stream data to build a real-time view, according to one embodiment.

FIG. 5 is a flowchart illustrating an example method for the batch processing module to process snapshot data to build a batch view, according to one embodiment.

FIG. 6 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Modern telecommunications networks are diverse and complex. Multiple vendors supply hardware and software to telecommunications service providers. Hardware and software from various vendors must interoperate seamlessly. Typically, OSSs for managing the networks are per network element based. Even though some OSSs are capable of providing a higher level view by spanning across multiple network elements, these OSSs will not support equipment supplied by other vendors.

Service fulfillment and service assurance of telecommunications network services require network orchestration to not only support multiple protocols and interfaces, but also be able to track network performance and utilization, and identify relationships between network elements based on information (e.g., inventory data, equipment configuration data, and service configuration data) in a timely manner to provide effective network orchestration.

Historically, the pace of network changes is slow. The procurement, installation, and commissioning process of physical networks can be time consuming. Network topology is largely static, and traffic routing options can be limited due to a small number of suitable network elements. One approach to manage a slow-changing network is to aggregate or batch the collection of information related to the network operations and build views of the network data that can be periodically updated. For example, a network orchestration system may ingest network data periodically from multiple data sources. The network orchestration system may then audit the ingested data and build a most trusted view based on the network data.

To ensure consistency, a network orchestration system may require processing of network data in a single batch and at a time when the network information is guaranteed to be immutable while network data in the batch is being processed and information can be sequenced correctly. The time taken to process the network data can be significant due to the volume of data being processed and the performance constraints imposed by the need for consistency.

As network infrastructures evolve rapidly, the approach of only building a most trusted view can face some challenges. For example, as networks are becoming more agile, customers of network operators can rapidly change how they utilize the network, in terms of geographical location, topology, or access technologies. For instance, a customer may roam between base stations in a cellular network or migrate between Wi-Fi and cellular networks. Network operators need to be able to track customer network usage and the topology of the service in near real time to address customer support issues and gain maximum value from network analytics. Tracking network usage and topology requires a large volume of network data to be quickly ingested and related to other information (e.g., topology, configuration, performance, and fault). If customers are experiencing network problems and the network operator does not have near real time information to help diagnose the problems, the network operator cannot offer a timely solution to the customers.

In another example, as networks adopt new technologies such as SDN and NFV, network configuration, topology, and service chains become more dynamic in nature because network changes can occur in seconds. Accordingly, a network orchestration system needs to support near real-time updates for network operators to effectively manage their networks. Dynamically changing networks are a paradigm change for operators who are used to manage relatively static physical networks. Understanding the impact of network changes as the changes occur is essential for effective management of the network.

Network Model

A complex telecommunications network may include thousands of network elements distributed across multiple regions and locations. Interconnected sites, equipment, and features may be controlled and maintained by different parties, and a single network element may be designed, implemented, and managed by different parties. Each party may maintain its own set of data related to network elements in the network. These data sets may be varyingly structured or largely unstructured, making it difficult to efficiently compare and analyze data from different sources. Embodiments of the present invention address this issue by normalizing disparate sets of network-related data using a network model, such that the normalized data can be handled by a single set of processes. The network model sets out a consistent structure to be applied to varying data from multiple sources, enabling automated processing of the data as a whole. This allows for efficient detection of data inconsistencies that helps to ensure network reliability.

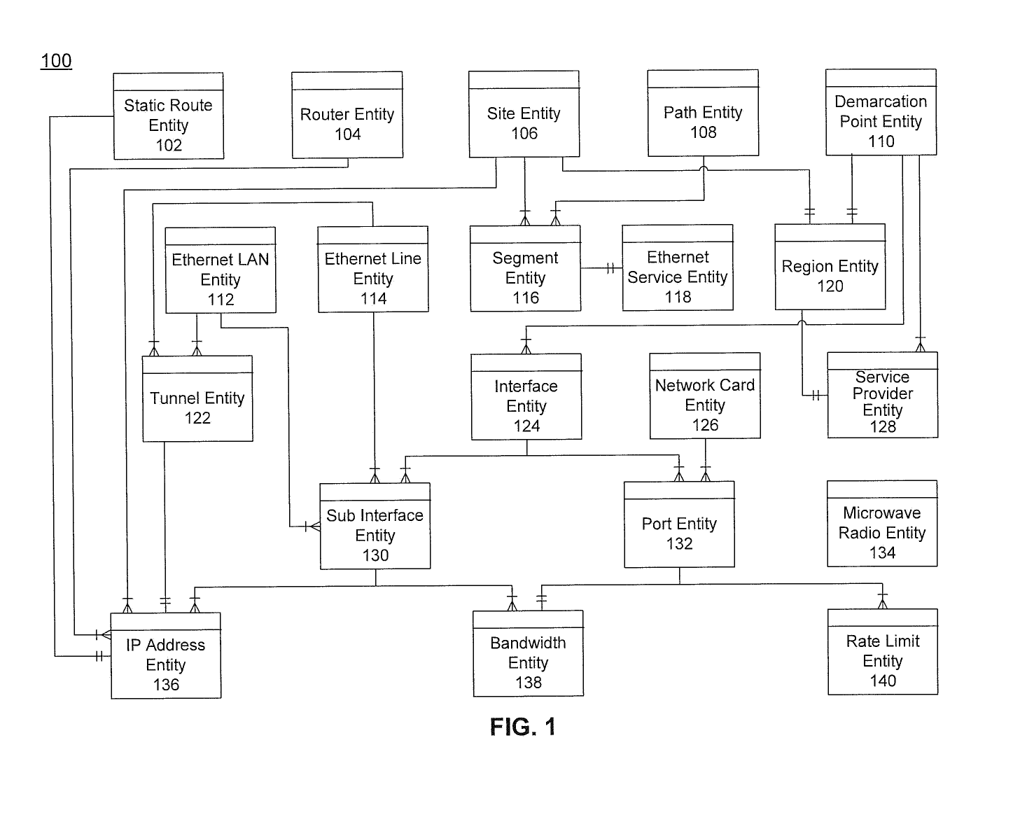

FIG. 1 is a diagram illustrating an example network model 100 that includes a plurality of network entities, each entity representing a type of network element in a telecommunications network. Network model 100 is illustrative and not intended to limit the present invention. A network element may refer to a specific facility, piece of equipment, or logical grouping of equipment used in the network. A network element may also refer to features, functions, and capabilities that are provided by such facility or equipment. Each network entity may include several attributes, which are not explicitly shown in FIG. 1.

Network model 100 includes static route entity 102, router entity 104, site entity 106, path entity 108, demarcation point entity 110, Ethernet LAN entity 112, Ethernet line entity 114, segment entity 116, Ethernet service entity 118, region entity 120, tunnel entity 122, interface entity 124, network card entity 126, service provider entity 128, sub interface entity 130, port entity 132, microwave radio entity 134, Internet Protocol (IP) address entity 136, bandwidth entity 138, and rate limit entity 140. The entities in the network model define the types of network elements in the network, and the network model defines the relationships between those types. In the embodiment of FIG. 1, line endings indicate the cardinality of a relationship. For example, the relationship marked with a bar and greater than sign between interface entity 124 and port entity 132 indicates that a network interface may include one or more ports, while the relationship between site entity 106 and region entity 120 marked with an equal sign indicates that a site is part of one region. FIG. 1 depicts one particular embodiment of a network model, and entities and relationships may be added, removed, or modified in other embodiments.

Each set of data may relate to a portion of network elements in the network, and each network element can be classified according to an entity in the network model. Network element attributes and relationships to other network elements may be populated as data from multiple sources and sets is noiiiialized, helping to depict the topological structure of the network as a whole. The aggregated, normalized data may then be analyzed to ensure data values are consistent across multiple sources and data sets.

In an embodiment, network model 100 is extensible in that entities may be added and removed from the model. As network technology evolves, it may be necessary to accommodate new types of network elements in the model. To incorporate a new entity into the network model, attributes and relationships to existing entities simply need to be defined. Similarly, entities may be removed from the model by deleting its relationships with other entities. Attributes and relationships of existing entities may also be updated and redefined as necessary. This allows for the network model to adapt to the changing structure of a telecommunications network.

System

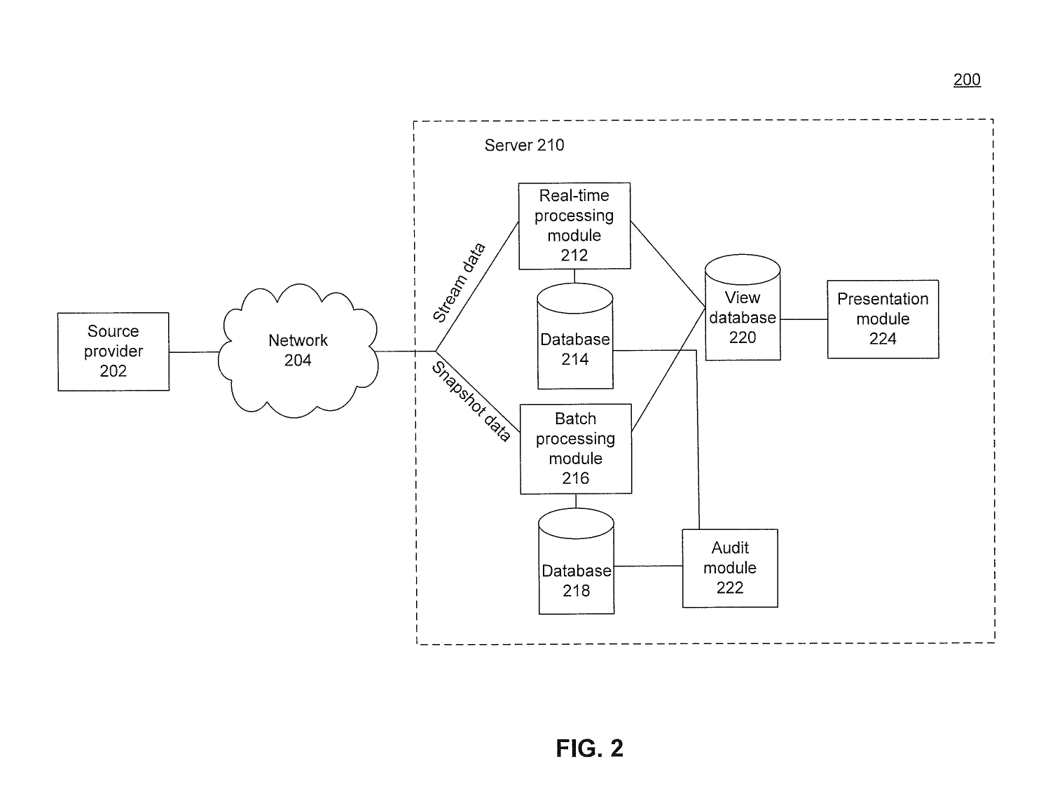

FIG. 2 is a diagram illustrating an example system for managing network elements in a telecommunications network from one or more source providers, according to an embodiment. System 200 includes one or more source providers 202 and one or more servers 210 connected by one or more networks 204, such as the Internet.

In the embodiment of FIG. 2, server 210, implemented on one or more processors, may run a network orchestration system that includes several components: real-time processing module 212, database 214 associated with real-time processing module 212, batch processing module 216, database 218 associated with batch processing module 216, view database 220, audit module 222, and presentation module 224. These components may be parts of a network orchestration system running on one or more servers 210. Server 210 may operate as described in further detail below with respect to FIGS. 2-4.

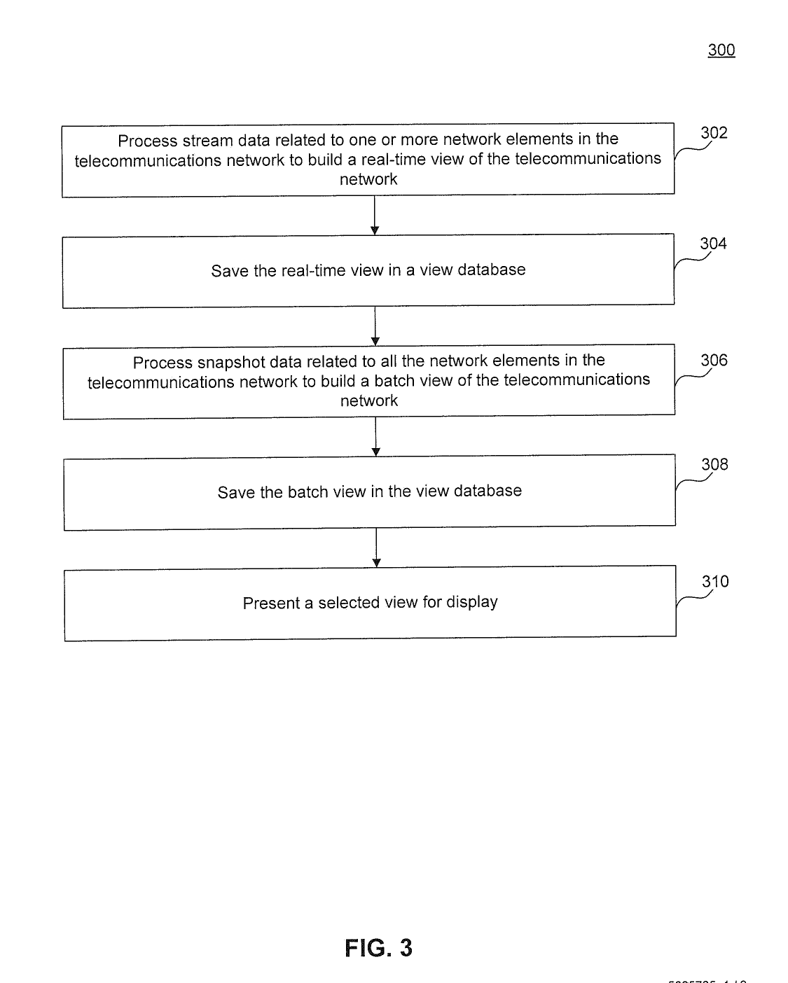

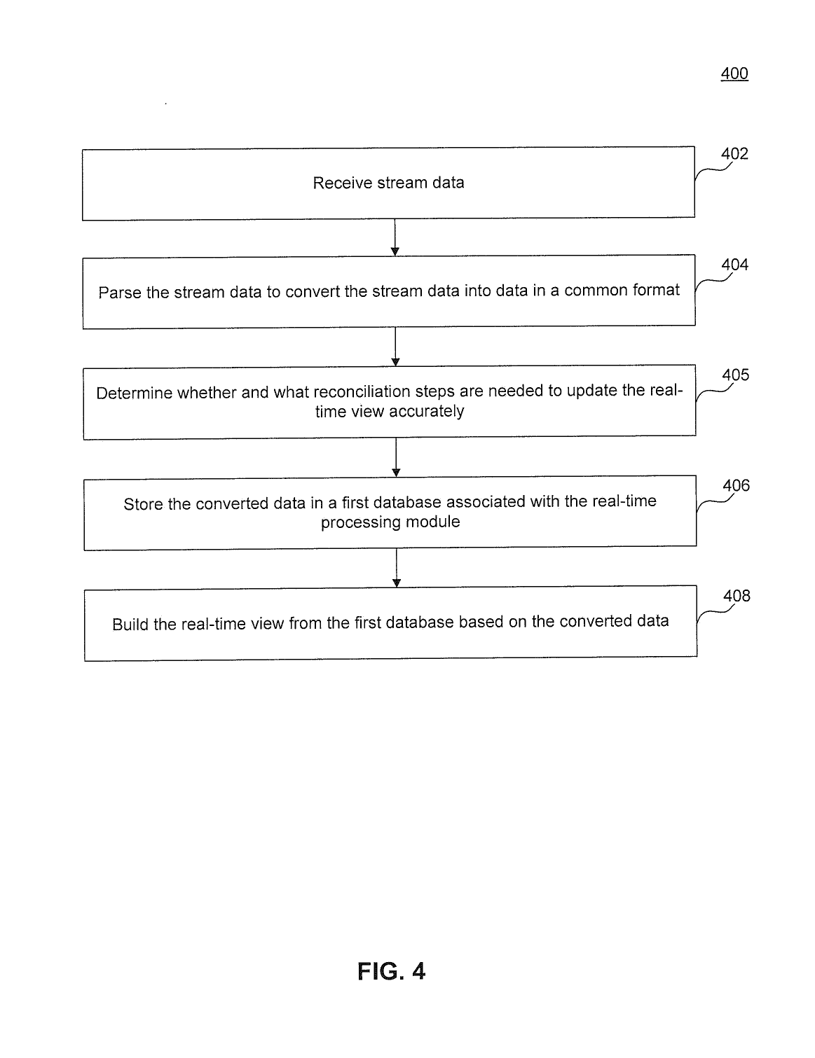

Real-time processing module 212 is responsible for receiving and processing stream data to build real-time views, as described with respect to FIGS. 3 and 4. Stream data is incremental data representing changes to one or more network elements of a communications network. For example, a communications network may consist of 200,000 network elements (e.g., routers). When changes are made to 20 of the 200,000 network elements (e.g., configuration changes to 20 of the routers), real-time processing module 212 receives stream data representing the incremental changes made to the 20 network elements. Incremental changes are sent to server 210 in a stream of data because incremental changes for a communications network could occur at any time.

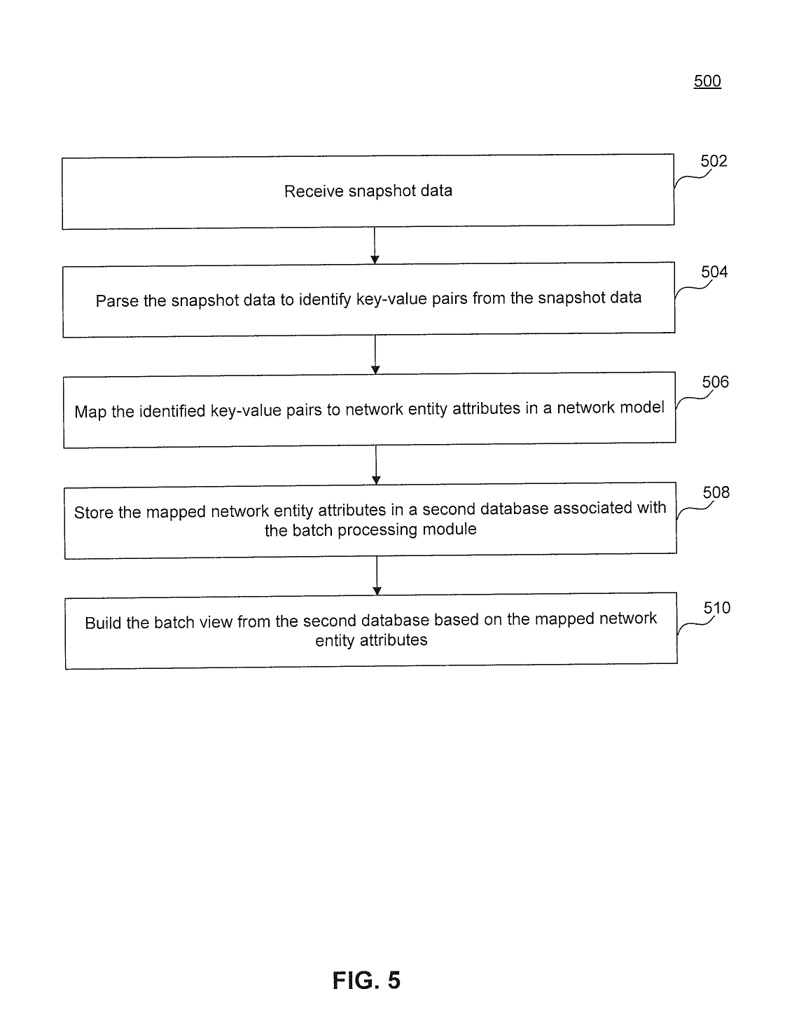

Batch processing module 216 is responsible for receiving and processing snapshot data to build batch views, as described with respect to FIGS. 3 and 5. In contrast to stream data, snapshot data is data representing complete information of all the network elements of a communications network at a point of time. Because snapshot data is significantly large (e.g., full configurations of all the 200,000 routers in a communications network), snapshot data is sent periodically, for example once every week, or even once every month for a larger communications network.

In an embodiment, stream data and snapshot data may be received via network 204, such as via a hypertext transfer protocol (HTTP) request generated by source provider 202. In other embodiments, source provider 202 may provide a physical document or a batch of physical documents, which may be manually loaded into system 200.

Once real-time processing module 212 receives the stream data related to one or more network elements, real-time processing module 212 parses the stream data to convert the stream data into data in a common format. Real-time processing module 212 may save the converted data in the common format in database 214 associated with real-time processing module 212. Real-time processing module 212 can quickly build a real-time view from database 214 based on the converted data in the common format. Real-time processing module 212 may build the real-time view by adding changes, as represented by the converted stream data, to a most recent view stored in view database 220. Real-time processing module 212 may save the built real-time view as the most recent view in view database 220.

Batch processing module 216 can receive snapshot data and parse the snapshot data to identify key-value pairs from the snapshot data. Batch processing module 216 may map the identified key-value pairs to network entity attributes in a network model. Batch processing module 216 then stores the mapped network entity attributes into database 218 associated with batch processing module 216. Batch processing module 216 can build, from database 218 based on the snapshot data, a batch view. Batch processing module 216 may save the built batch view as the most recent view in view database 220.

A batch view may support strong consistency. To further support data consistency, batch processing module may rely on audit module 222 for auditing data in database 218 to detect inconsistencies in the telecommunications network. Audit module 212 may first determine a set of audit rules to execute. An audit rule may target one or more network entity attributes in the network model. An audit rule may be very specific, such as targeting only the speed attribute of all ports within a particular network interface, or it may be broad, such as targeting all attributes of network elements at a particular network site. In an embodiment, an audit rule may be divided into a series of audit checks, where each audit check may perform a specific comparison or validation operation. Once data is retrieved from database 218, as specified by the audit rule, audit module 222 may determine if an inconsistency exists in the retrieved data.

Execution of the audit rule may include executing a series of comparison and validation operations on the retrieved data values. Comparison operations may compare data values associated with the same attribute and network element. For example, a value for the speed attribute of a specific port within the network may have been received from a network planner, an equipment installer, and an automated configuration report. By comparing these values, it is possible to quickly identify the source of an inconsistency. Validation operations may check to ensure that values meet set requirements. For example, a specific IP address may be expected to be within a set numerical range, and the validation operation may ensure that any deviation from this range is detected.

View database 220 stores views built by real-time processing module 212 and batch processing module 216. View database 220 may maintain a view marked as the most recent view. To further facilitate searching and retrieving of views stored in the view database, real-time processing module 212 or batch processing module 216 may associate properties with a view when the view is stored in the view database. The properties associated with a view may include the type of the view (e.g., a real-time or batch view). The properties may also include one or more timestamps of the view indicating how recent the stored view is and/or a consistency score indicating a level of consistency of data in the stored view.

Database 214, database 218, and database 220 may be any type of structured data store, including a relational or document-oriented database. To improve performance of database queries and updates, database 214 may also include an index table. Real-time processing module 212 queries the index table to assist with data insertions, updates, and retrieval. The index table may point to data entries in tables of database 214. In this manner, the index table may be used to improve performance of database queries and updates.

Presentation module 224 is responsible for presenting a view to a user in an interactive user interface. By default, presentation module 224 may present the most recent view from view database 220. In another embodiment, presentation module 224 may select a view from the view database based on pre-configured selection criteria. The pre-configured selection criteria may be, for example, the most recent view, or the most consistent view, or a combination of both. In another embodiment, the presentation module may present a list of views from the view database and display the list so that a user can select a view from the displayed list of views. The list of views may be a ranked list, and the order of the ranked list may be based on ranking criteria. The ranking criteria may be based on how recent the view is using the timestamps associated with the views, or how consistent the view is using the consistency scores associated with the views.

Each of the servers and components, including real-time processing module 212, database 214, batch processing module 216, database 218, view database 220, audit module 222, and presentation module 224, in FIG. 2 may be implemented on the same or different computing systems having server functionality, in hardware, software, or any combination thereof. Such computing systems can include, but are not limited to, a personal computer, a mobile device such as a mobile phone, workstation, embedded system, game console, television, set-top box, or any other computing system. Further, a computing system can include, but is not limited to, a device having a processor and memory, including a nontransitory memory, for executing and storing instructions. The memory may tangibly embody the data and program instructions. Software may include one or more applications and an operating system. Hardware can include, but is not limited to, a processor, memory, and graphical user interface display. The computing system may also have multiple processors and multiple shared or separate memory components on the same or different machines. The computing system may be a part of or the entirety of a clustered computing environment or server farm.

Method

FIG. 3 is a flowchart illustrating an example method 300 for processing data related to network elements in a telecommunications network, according to one embodiment. Method 300 begins at step 302 where a real-time processing module, such as real-time processing module 212 in FIG. 2, processes stream data related to changes to one or more network elements in the telecommunications network to build a real-time view of the network. A view is a modeled representation of a telecommunications network (or a portion of the network) that can be displayed in a user interface. The real-time processing module may be a part of a network orchestration system. The real-time processing module may receive the stream data from one or more source providers 202. Examples of source providers may be, but are not limited to, equipment within the network, equipment manufacturers, equipment installers, network operators (e.g., Internet service providers), network planners, vendors providing network analytics, or other network-related vendors. The stream data may be contained in a document. A document may refer to an electronic file, such as, but not limited to, a spreadsheet, word processing file, or XML file. In another embodiment, a document may refer to any collection of data, such as a result set from a database query. The document may also be associated with a location indicating where the source document resides. The stream data may be data related to changes to a communications network including, for example, changes to one or more network elements. Changes may include, for example, configuration changes made to routers, creation of a service or virtual network elements, insertion of a service or virtual network elements into a service chain or network function forwarding graph, and router configuration changes.

To quickly build a real-time view, the real-time processing module may leverage a fast ingest mechanism and a flexible database schema that supports very fast indexing and a high performance query. Further to the goal of producing the real-time view in a timely fashion, the real-time processing module may forego certain time consuming processing steps. For example, the real-time processing module may process the network data without detecting inconsistencies in the data (e.g., using auditing techniques such as cross-checking against other data sources). As the network changes continue to occur, the real-time processing module may build new views based on received data related to network changes. For example, the real-time processing module may build a new real-time view by modifying a most recent view to include the changes to a communications network as indicated in the stream data. Because the real-time processing module may produce the real-time views based on incremental changes and without checking data inconsistencies, the real-time views produced by the real-time processing module may not be consistent over time as the network keeps changing.

At step 304, the real-time processing module stores the built real-time view in a view database, such as view database 220 in FIG. 2. The view database is a database used to store views so that any view in the view database can be retrieved and displayed to the user in a user interface. View database 220 may maintain a view as the most recent view so that real-time processing module can build a real-time view based on stream data and the most recent view. The real-time processing module may store the built real-time view as the most recent view in view database 220. To facilitate searching and retrieving of views stored in the view database, the real-time processing module may associate properties with the real-time view when storing the view in the view database. The real-time processing module may store the associated properties with the real-time view in the view database. The properties associated a view may include the type of the view (e.g., a real-time view). The properties may also include a timestamp of the view indicating how recent the stored view is. The timestamp may be a creation timestamp including the time and date that the stream data was created, a receipt timestamp including the time and date that the stream data was received, and/or a build timestamp including the time and date that the real-time view was built. The properties may further include a consistency score indicating a level of consistency of data in the stored view. The real-time processing module may determine a consistency score without checking data consistency. For example, the consistency score may be detemiined based on the elapsed time between the built real-time view and the most recent view that guarantees data consistency.

At step 306, a batch processing module, such as batch processing module 216 in FIG. 2, processes snapshot data, related to complete information of all the network elements of a communications network at a point of time, to build a batch view of the network. The batch processing module may receive the snapshot data of all the network elements from one or more source providers 202. The snapshot data may be contained in a batch of documents including complete network information associated with the network elements. The batch processing module may leverage an ingest process and a database schema that supports strong consistency. The batch processing module may also build the batch view of the network data that are guaranteed to be consistent by detecting inconsistencies in the network data (e.g., using audit techniques such as cross-checking against other data sources).

To build a batch view, the batch processing module processes a much larger amount of data (the complete information about all the network elements in a communications network) and performs additional tasks (e.g., consistency checking) to support strong consistency. Building a batch view may take significantly more time than building a real-time view for the same telecommunications network because the batch processing module processes the snapshot data much slower than the real-time processing module processes the stream data related to changes to the network. On the other hand, data processing of the batch processing module may detect data inconsistencies.

Due the amount to time required to process snapshot data, the batch processing module may build batch views periodically at a predetermined time interval. For example, the predetermined time interval may be several days, weeks, or months. In another example, the batch processing module may build a batch view at a predetermined time.

At step 308, the batch processing module stores the built batch view in the view database. The network orchestration system may use the same view database, such as view database 220 in FIG. 2, to store both real-time views and batch views. The batch processing module can store the built batch view as the most recent view in view database 220. To facilitate searching and retrieving of views stored in the view database, the batch processing module may also associate properties with a batch view when storing the batch view in the view database. The batch processing module may store the associated properties with the batch view in the view database. The properties associated a view may include the type of the view (e.g., a batch view). The properties may also include a timestamp of the view indicating how recent the stored view is. The timestamp may be a creation timestamp including the time and date that the snapshot data was created, a receipt timestamp including the time and date that the snapshot data was received, and/or a build timestamp including the time and date that the batch view was built. The properties may further include a consistency score indicating a level of consistency of data in the stored view. For example, the consistency score may be determined based on the elapsed time between the built real-time view and the most recent view that guarantees data consistency.

At step 310, a presentation module, such as presentation module 224 in FIG. 2, may present a selected view for display in a user interface. By default, presentation module 224 can present the most recent view from view database 220. In addition, after the real-time processing module builds at least one real-time view and the batch processing module builds at least one batch view, these views are available for selection. For example, a selected view can be a real-time view or a batch view stored in the view database. In one embodiment, the presentation module may select a view from the view database based on pre-configured selection criteria. The pre-configured selection criteria may be, for example, the most recent view, or the most consistent view, or a combination of both.

In another embodiment, the presentation module may select a view from the view database based on attributes of the view, attributes of network elements contained in the view, pre-configured selection criteria, and/or the importance of network elements in the view to the user. Attributes of the view and attributes of network elements in the view, as well as criteria used for view selection, may include but are not limited to:

last modification time of the view or last modification time of network elements in the view;

the type of data of network elements in the view that have been changed;

the type of network elements in the view that have been changed;

the source of changes for the view or network elements in the view; and

the view information or the type of view information that the user is focusing on.

The view selection criteria may change over time depending on a user's viewing focus. For example, when a user wishes to view a high level summary of the network, the presentation module may select the most accurate real-time view from the view database for presentation to the user. Next, from the selected real-time view, user may select a subset of network elements that have not changed between a batch view and the real-time view, and the user may want to focus on the selected subset of network elements. Accordingly, the presentation module may select the batch view for the selected subset of elements so that the presentation module can present additional information of the selected subset of network elements in the batch view to the user. Finally, the user may select a second subset of network elements to focus on. For the second subset of network elements, changes may have occurred between the batch view and the real-time view, but the types of changes made to the real-time view are not important to the context. Accordingly, the presentation module may select the batch view for presentation because the additional information from the batch view is more important to the user than the changes made to the data in the real-time view.

In yet another embodiment, the presentation module may present a list of views from the view database and display the list in the user interface, so that a user can select a view from the displayed list of views. The list of views may be a ranked list, and the order of the ranked list may be based on ranking criteria. The ranking criteria may be based on how recent the view is using the timestamps associated with the views, or how consistent the view is using the consistency scores associated with the views. The presentation module may display a list of all views stored in the view database. Alternatively, the presentation module may display a list of a subset of views stored in the view database. For example, the presentation module may display a list of ten most recent views or ten views with the highest consistency scores. The presentation module may also display a list of views of which the timestamps or the consistency scores exceed a predetermined threshold value. After the user selects a view from the displayed list, the presentation module may receive the user selection of the view.

Once a view is selected, either by the presentation module or by a user, the presentation module presents the selected view for display to the user. For example, the presentation module may display the selected view through a web interface that allows a user to view and interact with data related to multiple network elements in a single view.

FIG. 4 is a flowchart illustrating an example method 400 for the real-time processing module to process stream data and build a real-time view, according to one embodiment. Method 400 describes exemplary details of step 302 of method 300. At step 402, the real-time processing module receives stream data related to changes to the one or more network elements in the telecommunications network. One or more source providers may send the stream data to the network orchestration system whenever changes occur. Alternatively, the one or more source providers may send the stream data in response to a query sent by the network orchestration system.

At step 404, the real-time processing module parses the stream data to convert the stream data related to the one or more network elements into data in a common format. Normally, multiple venders provide different types of network elements in a telecommunication network, and different types of network elements may send network data in different format. Parsing the received stream data into data in the common format helps the real-time processing module build the real-time view. Further, the common format may be a flexible database schema that supports fast indexing and high performance querying so that the real-time module may build the real-time view quickly.

As explained above, stream data may be network data related to update to a communications network. Update to the communications network may be complete changes for the data model representing the network elements or a partial update containing a fragment of the changes to the data model. Partially updated fragments may need to be complemented with information from other data sources to be useful. The real-time processing module may process a real-time update by initiating a discovery mechanism so that additional information of network elements related to the network update can be retrieved from various data sources and built into network data information. For example, a discovery mechanism may pull or access data associated with network elements so that the real-time processing module can check for updates indicative of changes in the status or configuration of network elements.

At step 405, the real-time processing module may optionally apply the network update to a view (e.g., the most recent view from view database 220) and determine whether and what reconciliation steps are needed to update the view accurately. Real-time network updates are subject to delays, message loss, and out-of-order communications. So the real-time processing module may perform reconciliation steps by identifying scenarios where applying the network update would result in an invalid network view. The real-time processing module may choose to apply the update, discard the update, retrieve data from authoritative data sources, or delay applying the update with the expectation that other related network updates will be received very soon.

At step 406, the real-time processing module stores the converted data in the common format in a first database, such as database 214 associated with the real-time processing module. The first database may be a database that can utilize fast indexing and high performance querying based on the flexible database schema. As described in method 300, the real-time processing module may skip certain time-consuming tasks, such as detecting data inconsistencies.

At step 408, the real-time processing module builds the real-time view from its associated database based on the converted data in the common format. The real-time processing module may build the real-time view for the one or more network elements associated with converted data (e.g., data related to the network elements of which the changes just occurred). For example, the real-time processing module may build a new real-time view by modifying a most recent existing view from the view database to include the changes to the network as indicated in the stream data. The real-time processing module may also find additional network elements from the first database, where the additional network elements are impacted by the changes to the one or more network elements. The real-time view built by the real-time processing module may include changes to these additional network elements as well.

FIG. 5 is a flowchart illustrating an example method 500 for the batch processing module to process network data and build a batch view, according to one embodiment. Method 500 describes exemplary details of step 306 of method 300. At step 502, batch processing module receives snapshot data related to complete information of all the network elements in a communications network. The snapshot data may be contained in a batch of documents. The batch of documents may contain complete network data associated with the all the network elements in the communications network. One or more source providers may send the snapshot data in response to a query periodically sent by the network orchestration system.

At step 504, the batch processing module parses the snapshot data. The batch processing module may parse the snapshot data according to parsing rules to identify relevant key-value pairs from the network data contained in the snapshot data. A parsing rule may target one or more network entity attributes in a network model representing the telecommunication network. Each key-value pair is associated with a network element in the telecommunications network. For example, a key-value pair may express the location of a network site or the bandwidth of a port of a particular network interface.

At step 506, the batch processing module maps the identified key-value pairs to appropriate network entity attributes in the network model. As described previously in FIG. 1, the network model is a hierarchical representation of network elements that compose the telecommunications network, and each network entity represents a type of network element in the network. For example, the network model may include a Port entity, and the Port entity may include a speed attribute related to the network speed of a port. An attribute may have a value in a pre-determined unit (e.g., Mbps). For example, if an identified key-value pair is a pair of bandwidth and 10,000 kbps, the batch processing module maps this key-value pair to 10 Mbps for the corresponding attribute of a Port entity.

At step 508, the batch processing module stores the mapped network entity attributes in a second database, such as database 218 associated with the batch processing module. An audit module, such as audit module 222 in FIG. 2, may help the batch processing module to audit data in the second database associated with the batch processing module to detect inconsistencies in the telecommunications network. An inconsistency may denote conflicting data values (e.g., a configuration setting that has been miscommunicated from a network planner to an equipment installer), or invalid data values (e.g., a performance reading that is inconsistent with an expected performance measurement). Inconsistencies such as these may lead to decreased reliability in the telecommunications network.

The audit module may first determine a set of audit rules to execute. An audit rule may target one or more network entity attributes in the network model. An audit rule may be very specific, such as targeting only the speed attribute of all ports within a particular network interface, or it may be broad, such as targeting all attributes of network elements at a particular network site. In an embodiment, an audit rule may be divided into a series of audit checks, where each audit check may perform a specific comparison or validation operation. Once data is retrieved from database associated with the batch processing module, as specified by the audit rule, the audit module may determine if an inconsistency exists in the retrieved data. When inconsistencies are detected, the audit module may distribute a report of inconsistencies automatically to relevant parties in order to remedy the inconsistency.

At step 510, the batch processing module builds the batch view from its associated database based on the mapped network entity attributes. To support strong consistency, the batch processing module may build the batch view from scratch using snapshot data in its associated database based on the mapped network entity attributes.

Example Computer System

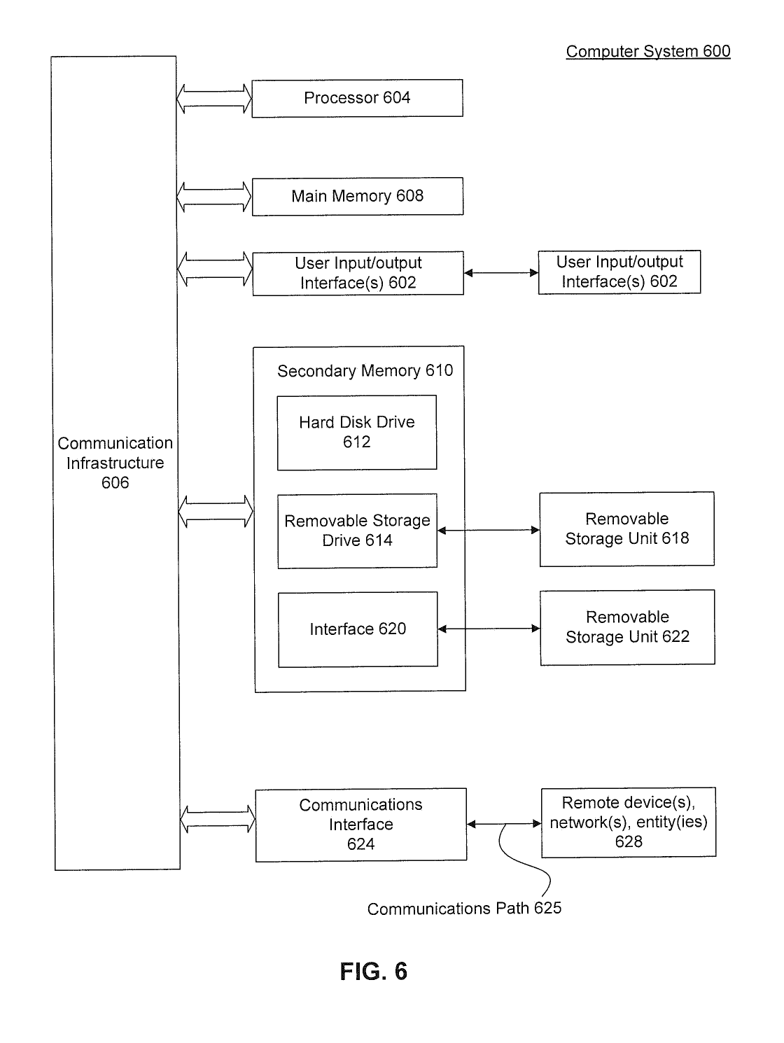

FIG. 6 is an example computing system useful for implementing various embodiments. Various embodiments can be implemented, for example, using one or more well-known computer systems, such as computer system 600. For example, server 210 in FIG. 2 may be implemented using computer system 600 to perform operations as described in FIGS. 3-5. Computer system 600 can be any well-known computer capable of performing the functions described herein, such as computers available from International Business Machines, Apple, Sun, HP, Dell, Sony, Toshiba, etc.

Computer system 600 includes one or more processors (also called central processing units, or CPUs), such as a processor 604. Processor 604 is connected to a communication infrastructure 606, for example, a bus or a network.

One or more processors 604 may also include a graphics processing unit (GPU), or other general purpose or specialized processing units. In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 600 also includes user input/output device(s) 603, such as monitors, keyboards, pointing devices, etc., which communicate with communication infrastructure 606 through user input/output interface(s) 602.

Computer system 600 also includes a main or primary memory 608, such as random access memory (RAM). Main memory 608 may include one or more levels of cache. Main memory 608 has stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/ any other computer data storage device. Removable storage drive 614 reads from and/or writes to removable storage unit 618 in a well-known manner.

According to an exemplary embodiment, secondary memory 610 may include other means, instrumentalities or other approaches for allowing computer programs and/or other instructions and/or data to be accessed by computer system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 enables computer system 600 to communicate and interact with any combination of remote devices, remote networks, remote entities, etc. (individually and collectively referenced by reference number 628). For example, communication interface 624 may allow computer system 600 to communicate with remote devices 628 over communications path 626, which may be wired and/or wireless, and which may include any combination of LANs, WANs, the Internet, etc. Control logic and/or data may be transmitted to and from computer system 600 via communication path 626.

In an embodiment, a tangible apparatus or article of manufacture comprising a tangible computer useable or readable medium having control logic (software) stored thereon is also referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), causes such data processing devices to operate as described herein.

Based on the teachings contained in this disclosure, it will be apparent to persons skilled in the relevant art(s) how to make and use the invention using data processing devices, computer systems and/or computer architectures other than that shown in FIG. 6. In particular, embodiments may operate with software, hardware, and/or operating system implementations other than those described herein. Computer system 600 may also have multiple processors and multiple shared or separate memory components on the same or different machines. Computer system 600 may also be a part of or the entirety of a clustered computing environment or server faint.

### CONCLUSION

In the foregoing description, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Identifiers, such as “(a),” “(b),” “(i),” “(ii),” etc., are sometimes used for different elements or steps. These identifiers are used for clarity and do not necessarily designate an order for the elements or steps.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described embodiments, but should be defined only in accordance with the following claims and their equivalents.

What is claimed is:

1. A method for managing network elements in a telecommunications network, comprising:
processing, by a real-time processing module, stream data representing changes to one or more network elements in the telecommunications network to build a real-time view of the telecommunications network;
saving the real-time view in a view database;
processing, by a batch processing module, snapshot data representing all the network elements in the telecommunications network to build a batch view of the telecommunications network, wherein the batch processing module processes the snapshot data slower than the real-time processing module processes the stream data; and
saving the batch view in the view database.

2. The method of claim 1, wherein the processing the stream data comprises:
building the real-time view of the telecommunications network by applying the changes, represented by the stream data, to a most recent view in the view database.

3. The method of claim 1, further comprising:
selecting a view from the view database based on selection criteria; and
presenting the selected view for display to a user.

4. The method of claim 1, further comprising:
presenting a ranked list of views for display to a user, wherein an order of the ranked list is based on ranking criteria;
receiving a user selection of a view in the ranked list; and
presenting the selected view for display to the user.

5. The method of claim 1, wherein the processing the stream data comprises:
receiving the stream data;
parsing the stream data to convert the stream data into data in a common format;
storing the converted data in a first database associated with the real-time processing module; and
building the real-time view from the first database based on the converted data and a most recent view in the view database.

6. The method of claim 1, wherein the processing the snapshot data comprises:
receiving the snapshot data;
parsing the snapshot data to identify key-value pairs from the snapshot data;
mapping the identified key-value pairs to network entity attributes in a network model; and
storing the mapped network entity attributes in a second database associated with the batch processing module; and
building the batch view from the second database based on the mapped network entity attributes.

7. The method of claim 6, wherein the processing the snapshot data further comprises:
auditing data in the second database to check data consistencies.

8. A system for managing network elements in a telecommunications network, comprising:
a memory; and
at least one processor coupled to the memory and configured to:
process, by a real-time processing module, stream data representing changes to one or more network elements in the telecommunications network to build a real-time view of the telecommunications network;
save the real-time view in a view database;
process, by a batch processing module, snapshot data representing all the network elements in the telecommunications network to build a batch view of the telecommunications network, wherein the batch processing module processes the snapshot data slower than the real-time processing module processes the stream data; and
save the batch view in the view database.

9. The system of claim 8, wherein the at least one processor is configured to build the real-time view by:
building the real-time view of the telecommunications network by applying the changes, represented by the stream data, to a most recent view in the view database.

10. The system of claim 8, wherein the at least one processor is further configured to:
select a view from the view database based on selection criteria; and
present the selected view for display to a user.

11. The system of claim 8, wherein the at least one processor is further configured to:
present a ranked list of views for display to a user, wherein an order of the ranked list is based on ranking criteria;
receive a user selection of a view in the ranked list; and
present the selected view for display to the user.

12. The system of claim 8, wherein the at least one processor is further configured to process the stream data by:
receiving the stream data;
parsing the stream data to convert the stream data into data in a common format;
storing the converted data in a first database associated with the real-time processing module; and
building the real-time view from the first database based on the converted data and a most recent view in the view database.

13. The system of claim 8, wherein the at least one processor is further configured to process the snapshot data by:
receiving the snapshot data;
parsing the snapshot data to identify key-value pairs from the snapshot data;
mapping the identified key-value pairs to network entity attributes in a network model; and
storing the mapped network entity attributes in a second database associated with the batch processing module; and
building the batch view from the second database based on the mapped network entity attributes.

14. The system of claim 13, wherein the at least one processor is further configured to process the snapshot data by:
auditing data in the second database to check data consistencies.

15. A non-transitory computer-readable medium having instructions stored thereon that, when executed by at least one computing device, causes the at least one computing device to perform operations for managing network elements in a telecommunications network, comprising:
processing, by a real-time processing module, stream data representing changes to one or more network elements in the telecommunications network to build a real-time view of the telecommunications network;
saving the real-time view in a view database;
processing, by a batch processing module, snapshot data representing all the network elements in the telecommunications network to build a batch view of the telecommunications network, wherein the batch processing module processes the snapshot data slower than the real-time processing module processes the stream data; and
saving the batch view in the view database.

16. The non-transitory computer-readable medium of claim 15, wherein the processing the stream data comprises:
building the real-time view of the telecommunications network by applying the changes, represented by the stream data, to a most recent view in the view database.

17. The non-transitory computer-readable medium of claim 15, further comprising:
selecting a view from the view database based on selection criteria; and
presenting the selected view for display to a user.

18. The non-transitory computer-readable medium of claim 15, further comprising:
presenting a ranked list of views for display to a user, wherein an order of the ranked list is based on ranking criteria;
receiving a user selection of a view in the ranked list; and
presenting the selected view for display to the user.

19. The non-transitory computer-readable medium of claim 15, wherein the processing the stream data comprises:
receiving the stream data;
parsing the stream data to convert the stream data into data in a common format;
storing the converted data in a first database associated with the real-time processing module; and
building the real-time view from the first database based on the converted data and a most recent view in the view database.

20. The non-transitory computer-readable medium of claim 15, wherein the processing the snapshot data comprises:
receiving the snapshot data;
parsing the snapshot data to identify key-value pairs from the snapshot data;
mapping the identified key-value pairs to network entity attributes in a network model; and
storing the mapped network entity attributes in a second database associated with the batch processing module; and
building the batch view from the second database based on the mapped network entity attributes.

21. The non-transitory computer-readable medium of claim 15, wherein the processing the snapshot data further comprises:
auditing data in the second database to check data consistencies.
